(19) United States
(12) Patent Application Publication
(10) Pub. No.: US 2019/0250690 A1
(43) Pub. Date: Aug. 15, 2019

(54) VIDEO PLAYBACK ENERGY CONSUMPTION CONTROL

(71) Applicant: Futurewei Technologies, Inc., Plano, TX (US)

(72) Inventors: Jun Wang, Santa Clara, CA (US); Xiaocun Que, Santa Clara, CA (US); Jiangsheng Yu, San Jose, CA (US); Hui Zang, Cupertino, CA (US); Handong Ye, Sunnyvale, CA (US)

(21) Appl. No.: 15/892,633

(22) Filed: Feb. 9, 2018

(51) Int. Cl. G06F 1/32

(52) U.S. Cl. CPC G06F 1/324; G06F 1/3206

(57) ABSTRACT

A computer implemented method of controlling energy consumption of a battery powered device includes determining, by the device, a state of the device responsive to the device playing a video wherein the state of the device is based on a CPU utilization rate of a CPU of the device, selecting, by the device, a policy of a plurality of different policies based on the determined state, wherein each policy comprises a respective CPU frequency setting and a respective memory bandwidth setting, and applying the CPU frequency setting of the selected policy to the CPU and the memory bandwidth setting of the selected policy to a speed setting of a memory bus of the device.

### TECHNICAL FIELD

The present disclosure is related to video playback, and in particular to controlling energy consumption during video playback.

### BACKGROUND

The playback of video content on battery powered devices drains the battery quickly. Battery life is one of the top concerns of every mobile phone user. Over the years, numerous techniques, both hardware and software, have been proposed to improve energy efficiency of mobile devices and many have been adopted by commercial products.

### SUMMARY

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, a computer implemented method of controlling energy consumption of a battery powered device includes determining, by the device, a state of the device responsive to the device playing a video wherein the state of the device is based on a CPU utilization rate of a CPU of the device, selecting, by the device, a policy of a plurality of different policies based on the determined state, wherein each policy comprises a respective CPU frequency setting and a respective memory bandwidth setting, and applying the CPU frequency setting of the selected policy to the CPU and the memory bandwidth setting of the selected policy to a speed setting of a memory bus of the device.

Optionally, in any of the preceding aspects, a further implementation of the aspect includes for each of a plurality of different combinations of CPU frequency settings and memory bandwidth settings, determining, by the device, a respective first state of the device while the device is playing a first video, applying, by the device, the CPU frequency setting of the combination to the CPU and the memory bandwidth setting of the combination to the speed of the memory bus and, thereafter, computing a reward value for combination based on a fps of the first video while it is playing and power utilization of the device while the first video is playing, and associating, by the device, the first state and the reward value and with the combination.

Optionally, in any of the preceding aspects, a further implementation of the aspect includes selecting, by the device, a combination having a greatest reward value among combinations associated with each different first state to produce the plurality of policies.

Optionally, in any of the preceding aspects, a further implementation of the aspect includes wherein computing the reward value for the combination comprises calculating

$$\frac{1}{max ( 0 , F - fps ) + \tilde{λ} * power} ,$$

where F is a target frames per second, fps is a value of the frames per second of the first video while it is playing, λ is a power penalty constant, and power is a rate of power utilization of the CPU while the first video is playing.

Optionally, in any of the preceding aspects, a further implementation of the aspect includes wherein fps=24 and λ<1.

Optionally, in any of the preceding aspects, a further implementation of the aspect includes the combinations are evaluated in a random order.

According to one aspect of the present disclosure, a battery powered device includes a memory storage device comprising instructions and a central processing unit (CPU) in communication with the memory storage device, wherein the CPU is configured to execute the instructions to perform operations including determining, by the device, a state of the device responsive to the device playing a video wherein the state of the device is based on a CPU utilization rate of a CPU of the device selecting, by the device, a policy of a plurality of different policies based on the determined state, wherein each policy comprises a respective CPU frequency setting and a respective memory bandwidth setting, and applying the CPU frequency setting of the selected policy to the CPU and the memory bandwidth setting of the selected policy to a speed setting of a memory bus of the device.

Optionally, in any of the preceding aspects, a further implementation of the aspect includes for each of a plurality of different combinations of CPU frequency settings and memory bandwidth settings, determining, by the device, a respective first state of the device while the device is playing a first video, applying, by the device, the CPU frequency setting of the combination to the CPU and the memory bandwidth setting of the combination to the speed of the memory bus and, thereafter, computing a reward value for combination based on a fps of the first video while it is playing and power utilization of the device while the first video is playing, and associating, by the device, the first state and the reward value and with the combination.

Optionally, in any of the preceding aspects, a further implementation of the aspect includes selecting, by the device, a combination having a greatest reward value among combinations associated with each different first state to produce the plurality of policies.

Optionally, in any of the preceding aspects, a further implementation of the aspect includes wherein computing the reward value for the combination comprises calculating

$$\frac{1}{max ( 0 , F - fps ) + \tilde{λ} * power} ,$$

where F is a target frames per second, fps is a value of the frames per second of the first video while it is playing, λ is a power penalty constant, and power is a rate of power utilization of the CPU while the first video is playing.

Optionally, in any of the preceding aspects, a further implementation of the aspect includes wherein fps=24 and λ<1.

Optionally, in any of the preceding aspects, a further implementation of the aspect includes the combinations are evaluated in a random order.

According to one aspect of the present disclosure, a non-transitory computer-readable media stores computer instruction for controlling energy consumption of a device, that when executed by a central processing unit (CPU), cause the CPU to perform the steps of determining, by the device, a state of the device responsive to the device playing a video wherein the state of the device is based on a CPU utilization rate of a CPU of the device, selecting, by the device, a policy of a plurality of different policies based on the determined state, wherein each policy comprises a respective CPU frequency setting and a respective memory bandwidth setting, and applying the CPU frequency setting of the selected policy to the CPU and the memory bandwidth setting of the selected policy to a speed setting of a memory bus of the device.

Optionally, in any of the preceding aspects, a further implementation of the aspect includes for each of a plurality of different combinations of CPU frequency settings and memory bandwidth settings, determining, by the device, a respective first state of the device while the device is playing a first video, applying, by the device, the CPU frequency setting of the combination to the CPU and the memory bandwidth setting of the combination to the speed of the memory bus and, thereafter, computing a reward value for combination based on a fps of the first video while it is playing and power utilization of the device while the first video is playing, and associating, by the device, the first state and the reward value and with the combination.

Optionally, in any of the preceding aspects, a further implementation of the aspect includes selecting, by the device, a combination having a greatest reward value among combinations associated with each different first state to produce the plurality of policies.

Optionally, in any of the preceding aspects, a further implementation of the aspect includes wherein computing the reward value for the combination comprises calculating

$$\frac{1}{max ( 0 , F - fps ) + \tilde{λ} * power} ,$$

where F is a target frames per second, fps is a value of the frames per second of the first video while it is playing, λ is a power penalty constant, and power is a rate of power utilization of the CPU while the first video is playing.

Optionally, in any of the preceding aspects, a further implementation of the aspect includes wherein fps=24 and λ<1.

Optionally, in any of the preceding aspects, a further implementation of the aspect includes wherein the combinations are evaluated in a random order.

### BRIEF DESCRIPTION OF THE DRAWINGS

FIG. 1 is a block diagram of a system for managing energy consumption during video playback according to an example embodiment.

FIG. 2 illustrates a policy table comprising a policy having actions for each state of a device playing video according to an example embodiment.

FIG. 3 is a flowchart illustrating a method for generating a policy for managing energy consumption during video playback according to an example embodiment.

FIG. 4 is a flowchart illustrating an example method for minimizing energy consumption during video playback according to an example embodiment.

FIG. 5 is a flowchart illustrating a further example method of controlling energy consumption of a battery powered device playing a video according to an example embodiment.

FIG. 6 is a flowchart illustrating an example method of generating a policy table for multiple different states according to an example embodiment.

FIG. 7 is an example of a learning table of multiple device states and corresponding reward calculations for multiple different actions in each device state according to an example embodiment.

FIG. 8 is a block diagram illustrating suitable circuitry for implementing algorithms and performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

Dynamic Voltage and Frequency Scaling (DVFS) has been used to improve power efficiency of mobile devices, and hence increase the time between recharging the batteries of mobile devices. DVFS is a circuit-level technology that regulates power consumption by dynamically adjusting the system's voltage and frequency. It is based on the model that an integrated circuit's power consumption is made up of two major components: the dynamic power and the static leakage power (Pₜₒₜₐₗ=P_{dyn}+Pₗₑₐₖ). Such power consumption components are functions of voltage and clock frequency.

The Linux OS (operating system) initially supported DVFS with a subsystem known as cpufreq. The cpufreq subsystem defines a number of policies known as governors. An ondemand governor, for instance, works by constantly monitoring the CPU (central processing unit) load and switching to the highest frequency when the load goes above a predefined threshold. In the same spirit, Linux also contains a subsystem called devfreq. Through the corresponding governors, the clock frequency for a device, such as the memory bus, can be controlled.

Android systems run a Linux kernel and thus inherit its power management components such as cpufreq and devfreq. In fact, these are the most prominent power management mechanisms on Android systems.

DVFS techniques, as described above, are general-purpose system techniques based on low-level indication of system state such as CPU utilization. They are agnostic to which application is being run in the foreground. They are also device-agnostic in the sense that the same governor algorithms are used on different devices, even devices from different generations or different vendors. Consequently, they produce mixed results when running different apps. Application-specific customization of the governors can lead to significant energy savings compared to using stock governors.

Video playback for years has been highly popular among mobile device users. Because of its high demand on hardware resources, video playback has always been a heavy energy consumer, particularly as high-definition videos are becoming more and more popular.

Embodiments of the present inventive subject matter provide energy management of video playback on battery powered devices by utilizing reinforcement learning (RL). RL generally involves taking an action on an environment, obtaining a state of the environment and a reinforcement signal (reward) resulting from the action, and taking another action. This process is repeated to learn which actions have the best results for each state of the environment, or in this case, a battery powered mobile device which may be running many different apps.

In one embodiment, an RL agent is deployed on a device. Through a learning process, the RL agent learns what action to take, such as what DVFS settings to select, in each device state in order to minimize energy consumption while maintaining video quality. At the end of the learning process, this knowledge is stored in a policy file as the learned policy. Responsive to video playback occurring, a governor executing on a central processing unit (CPU) uses the policy file to repeatedly select DVFS settings based on the device state.

In some embodiments, the learning process may be repeated each time a new video is played, or a learned policy may be used for multiple video playbacks. Note that during playback of a video with a selected DVFS setting, the device state may change. The learned policy may be used to modify the DVFS settings responsive to such state changes during playback, resulting in energy savings which prolongs the life of the device battery allowing for longer periods of video playback without having to recharge the battery in addition to ensuring high quality video playback. The settings are also customized for each device as the learning process is performed on the device in the environment in which the device is operating.

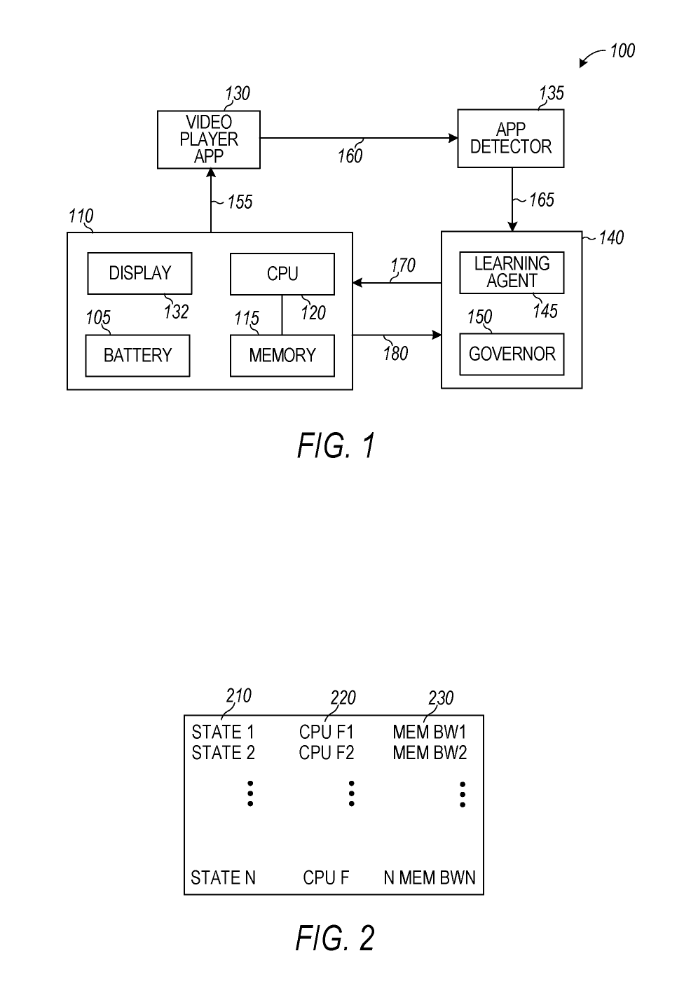

FIG. 1 is a block diagram of a system 100 that manages energy consumption during playback of video content. The system consists of a battery 105 powered device 110, such as a mobile phone, touchpad, or other device via which video can be displayed to one or more users. The video may be provided via a video streaming service or from a local storage device. The device 110 includes a CPU 120, which may consist of one or more processors for executing code stored in a memory 115. The memory 115 is one example of a local storage device on which the video may be stored and played from. Further examples include a hard disk drive, semiconductor disk drive, flash drive, or other type of storage.

A video player application or app 130 (MxPlayer for example) may receive video content and play the video. App 130 may be executed by CPU 120 from memory 115 to display video on a display 132 of device 110. The app 130, or alternatively, an app detector 135, may provide information about the video in the form of a frames per second (fps) rate to a module 140. Such information may be obtained via a file containing information maintained by an operating system executing on the CPU 120 and stored in memory 115, for example. Alternatively, the FPS can be obtained from the video player app 130. Module 140 may include a learning agent 145 and a governor 150. The learning agent 145 operates to learn which actions for different device states result in playing the video with sufficient quality while consuming the least amount of energy from the battery 105. Each of the apps and modules may be executed by CPU 120 from memory 115 in one embodiment.

Communication channels are represented by line 155 between device 110 and app 130, line 160 between app 130 and app detector 135, line 165 between app detector 135 and module 140, and lines 170 and 180 between module 140 and device 110. Line 155 represents a communication channel that provides video content to the video player app 130. Video processing by CPU 120 consumes a significant number of CPU cycles to decompress video and convert the video to a displayable format.

Line 160 is optional and represents a communication channel for indicating that the video player app 130 is about to or has begun playing a video on display 132. The video player app 130 may provide that communication via line 160 directly to the app detector, or directly to module 140. The communication may also originate from the operating system in memory 115, and may be generated responsive to operating system tracking of CPU utilization by each app running on device 110. A further method includes the app detector 135 being provided a list of video playing apps and checking a foreground app against the list. The playing of a video will result in a sharp spike in CPU utilization by app 130. The sharp spike in CPU utilization by a video playback app may be detected by the operating system and used to trigger the communication to app detector 135 responsive to the utilization crossing a threshold. The threshold may vary between systems and may be set based on empirical data for each system. The app detector 135 may alternatively periodically check for such a spike to determine that the video play app 130 is playing a video.

Information about the playing of video, such as fps and display resolution may be obtained via an operating system file that maintains such information. The fps and resolution may be provided via line 165 to the module 140. Line 170 is used to provide energy utilization settings, referred to as actions, to the CPU 120. Such actions may include a DVFS setting, such as a pair of CPU frequency (CPU f) and memory bandwidth (Mem BW) settings. The Mem BW may correspond to a speed setting for a memory bus, for example. One example Mem BW setting may be 300 MBps for current memory technology, meaning that the memory can transfer no more than 300 megabytes of data per second. Faster or slower speeds may be used. Other parameters that affect power consumption or performance may also be modified, such as graphics processing unit (GPU) frequency for example. Line 180 communicates a state of device 110 and a reinforcement signal to the module 140.

In operation, module 140 is divided into two different phases. A learning phase utilizes agent 145 to test different actions for different states of the device 110. Agent 145 then creates a policy table 200, as shown in FIG. 2. Policy table 200 comprises the learned policy and contains the best action for each state. In a controlling phase, governor 150 obtains a state of the device 110 and uses the policy table that contains actions for each state at column 210 resulting in energy conservation while maintaining an acceptable video quality. The actions include CPU frequency f at column 220 and Mem BW at column 230. The governor 150 provides the actions to the device 110 for implementation. Higher resolution videos may benefit more from energy saving actions than lower resolution videos. Different policy tables 200 may be used for different resolution videos.

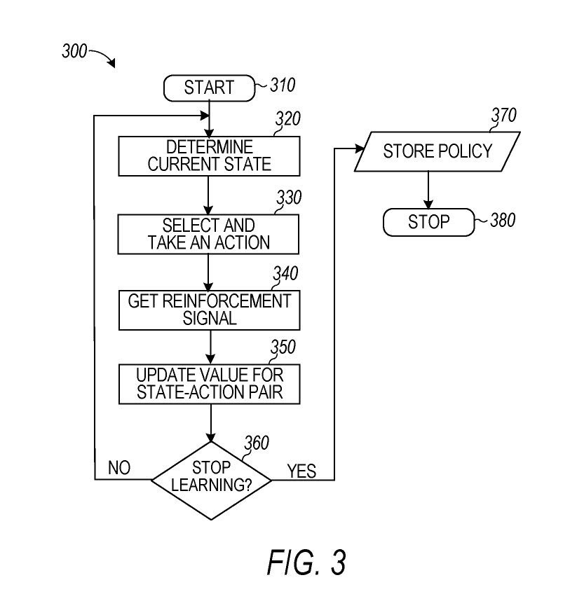

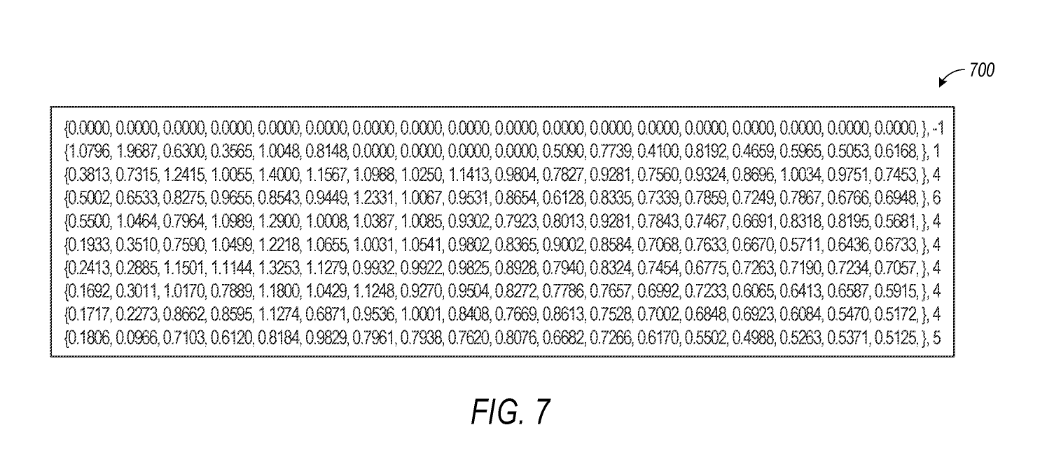

FIG. 3 is a flowchart illustrating a method 300 performed by the agent 145 in an example embodiment to learn optimal actions for each state to conserve energy during video playback. The method can be performed by device 110, for example. Method 300 starts at operation 310 responsive to the video player app 130 starting to perform a video playback. The app detector 135 may detect this action, such as by receiving a communication that video playback has started or is about to start and measures the fps of the video playback and its resolution of the playback. These data are passed to the agent 145 which maintains a learning table 700 shown in FIG. 7 and described in further detail below.

At operation 320, the current device state is obtained from an operating system-maintained file, for example. The device state may be a percentage of CPU utilization, which may also be provided by the operating system for all processes or for just the app 130. Either CPU utilization percentage may be used in different embodiments, as other apps, referred to as background apps, consistently utilize much less of the CPU than the app 130 making the differences negligible. The percentage may vary from just above zero percent to about 100% in various embodiments. The CPU utilization percentage may be divided into a discrete number of states, such as ten. Each state may cover an equal range of percentages. More or fewer states may be used in further embodiments and the range of percentages for each state may vary to optimize energy consumption with finer granularity. The number of states may be determined empirically and may vary for different devices with different CPUs.

At 330, an action is selected and taken. The action may be randomly selected in some embodiments or may be simply cycled through a number of allowed combinations of CPU f and Mem BW to ensure all combinations in different states are tested. At 340, after a pre-defined period has passed with the new CPU frequency and memory frequency being used by device 110, a reinforcement signal is obtained to determine how well energy is being utilized given the action taken. The reinforcement signal is calculated using a reward function that is based on a resulting fps value compared to a desired fps value and the power being utilized. The pre-defined period should be long enough for a new state to have settled following application of the action, such as 1 second for example. Different periods may be used in different embodiments, balancing between speeding up the learning time and obtaining accurate setting for each state.

The reward function is inversely proportional to a number of fps less than a constant number of fps deemed to be of sufficient quality plus a penalty constant times the rate of power utilization. In one embodiment, the reinforcement signal is defined as a reward=1/(max(0, F-fps)+λ*power).

F is a target value of video frames per second, while fps is the actual value of video frames per second of the playing video. The max function ensures that the smallest value of max(0, F-fps) can be zero. “F-fps” may also result in zero when the measured fps is the same as or higher than the desired value of F, which is 24 frames per second in one embodiment. Note that an fps that is higher than F is not rewarded.

λ is a power penalty constant that may vary between different devices, such as 0.001 in one embodiment, and power is a value of power utilization maintained in a file by the operating system that may be read from the file. In further embodiments, the rate of power utilization may be obtained from a model based on CPU utilization rate and memory bandwidth. As either or both power utilization increases and fps decreases, the reward decreases. In other words, there are penalties for both low fps and high power utilization. Note that the λ power penalty constant can result in “λ*power” being less than one, so that a reward can be greater than one provided the max(0, F-fps) function is zero. λ may be increased to weight power considerations more heavily, or decreased to weight quality considerations more heavily.

At operation 350, method 300 updates the learning table with values for each state-action pair. The learning table includes the reward for each state-action pair, which later enables a search of the learning table to determine which state-action pair corresponds to the highest reward for each state. The highest reward state-action pairs are then used to generate policy table 200.

At decision operation 360, it is determined if all action pairs for all states have been sufficiently evaluated such that learning may stop. Sufficiently evaluated may include a determination that all possible action pairs for each state have been evaluated and the policy table 200 is complete in one embodiment, or may simply mean that a predetermined number, such as 1000, state action pairs have been updated. In further embodiments that may utilize randomized selection of actions during operation 330, sufficiently evaluated may include that a number of iterations or cycles sufficient to have likely found most optimal action pairs for most states may be used as criteria for stopping learning at 360.

If the decision at operation 360 is that learning should not stop, method 300 returns to operation 320 to determine a new current state. If learning should stop, the best state and action pairs are stored in the policy table at 370, and method 300 stops at operation 380 to transfer control to the governor 150. The policy table 200 thus incorporates the learned policy. In various embodiments, the learned policy may be learned each time a video is beginning to be played. In further embodiments, that same learned policy may be used for multiple different video playbacks. A different policy may be learned and used for different video player apps or for different video servers, or for different resolution videos.

In one embodiment, selection of a next action to take at 330 may alternate between random selection (first type of action selection) and selection from a set of ordered actions (second type of action selection) which may be included in the learning table. A pseudocode example of a random selection is as follows:

*** Select action 17 randomly
CPU utilization= 0.25 fps= 23.85
In state 6 take action 17 rwd= 0.5768 new state= 2
updating value of state 6 and action 17:
Step= 142 State= 6 Action= 17 Reward= 0.5768

The above represents a first action selection. The action may be selected randomly in some embodiments. The first type of action selection in this example is performed 50% of the time. Note that the available actions are numbered in this example with action 17 being randomly selected. The number of available actions may correspond to the number of CPU f settings times the number of Mem BW settings. The actions and states are stored in the learning table. A CPU utilization of 0.25 and fps of 23.85 in state 6 is noted, along with action 17 that was randomly selected, resulting in a reward of 0.5768 and a new state=2. The learning table is updated at step 142 with a state of 6, an action of 17, and a resulting reward of 0.5768. The second selection in this example is made based on the next action from the learning table:

### Select action 2 in state 2
CPU utilization= 0.71 fps= 23.84
In state 2 take action 2 rwd= 1.2065 new state= 7
updating Q value of state 2 and action 2:
Step= 143 State= 2 Action= 2 Reward= 1.2065

In state 2, the second action is taken in accordance with the second type of action selection, resulting in a reward of 1.2065, and a new state 7. The learning table is updated at step 143 with state=2, action=2, and reward=1.2065. A next action may be selected randomly with successive actions selected alternating between the first and second types of action selections. In further embodiments the ratio of selection using the different types of actions may vary from using one type for all selections, to alternating types.

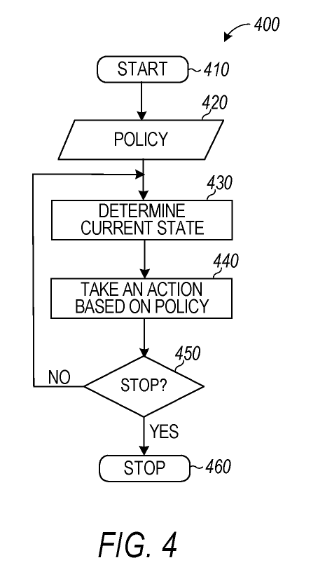

FIG. 4 is a flowchart illustrating an example method 400 performed by the governor 150 to minimize energy consumption during video playback. Method 400 starts at operation 410 responsive to detection of video playback. In one embodiment, the fps and resolution are passed by app detector 135 to the governor 150. The governor 150 utilizes the policy table 200 generated by method 300. The policy table 200, that incorporates the learned policy for the particular app and video resolution, is loaded at operation 420. A current state is determined at operation 430. The state may be obtained from a file maintained by the operating system in one embodiment, and may include a CPU utilization rate. The state may be derived from the CPU utilization rate by determining which range includes the obtained CPU utilization rate. At operation 440, the state is used to index into the policy table 200 incorporating the policy to obtain an action and provide the action back to device 110 for implementation of the action. The action may include DVFS commands for the video playback.

A decision operation 450 is used to determine whether or not to stop. Operation 450 may cause the method to stop at 460 responsive to the video being stopped or paused, or if the governor is only configured to initialize the device settings at the beginning of video playback. If the governor is to continue monitoring the playback and device settings, processing may return to operation 430 to determine the current state. The return may be periodically performed, such as once every few seconds or minutes. Continued monitoring of the playback can be useful in the event there are changes to either playback parameters, such as fps or resolution, which can affect power utilization and hence energy consumption, or if other apps become active that may affect power utilization. In such cases, the state of the device may change and may result in a new action being identified and implemented.

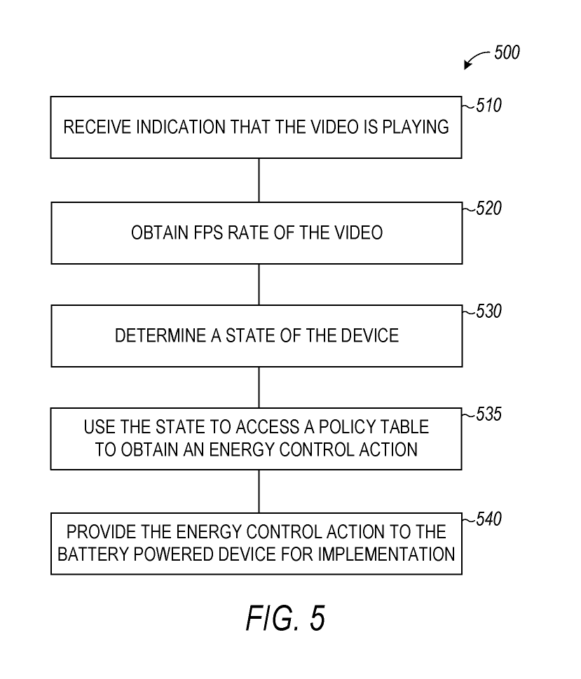

FIG. 5 is a flowchart illustrating an alternative method 500 of controlling energy consumption of a battery powered device playing a video. At operation 510 an indication that the video is playing on the battery powered device is received. The battery powered device has a CPU processing the video stream as well as executing instructions to perform method 500.

At operation 520, the CPU obtains an fps rate of the video that is playing. At operation 530, the CPU determines a state of the device playing the video based on a CPU utilization rate. Responsive to determining the state, the CPU uses the state to access the policy table 200 at operation 535. Policy table 200 has multiple states and corresponding energy control actions. The policy table 200 provides an energy control action corresponding to the state.

The energy control action comprises a CPU frequency setting, CPU frequency, f, and memory bandwidth setting, Mem BW. The Mem BW may correspond to a speed setting for a memory bus, thus effectively controlling the rate at which a memory device can provide data. Slower rates consume less power and hence less energy over time than faster rates. The energy control actions for each state are based on a reward function that rewards both quality of the video playing measured by fps and a rate of power utilization for each state. At operation 540, the energy control action is provided to the battery powered device for implementation.

The selected energy control action is one of a number of energy control actions. In one embodiment, the energy control action is selected from one of a selected number of CPU frequency settings times a number of memory bandwidth settings.

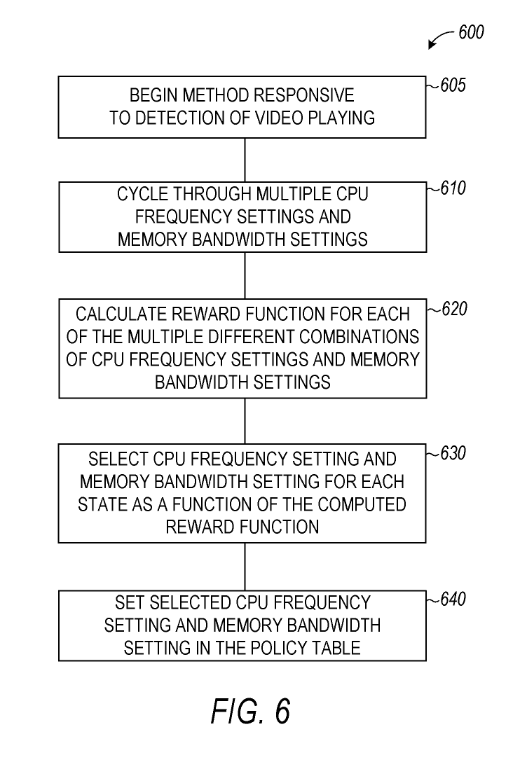

FIG. 6 is a flowchart of an example method 600 for generating the policy table 200 via operations executed on the CPU for multiple different states. Method 600 begins at operation 605 responsive to a video being detected as playing. Method 600 cycles through multiple CPU frequency settings and memory bandwidth settings as indicated at operation 610. A reward function is calculated at operation 620 for each of the multiple different combinations of CPU frequency settings and memory bandwidth settings. At operation 630, a CPU frequency setting and memory bandwidth setting is selected for each state as a function of the computed reward function. Operation 640 sets the selected CPU frequency setting and memory bandwidth setting in the policy table. Method 600 may be performed prior to method 500, and provides the policy table for use by method 500 in accessing the policy table and applying the energy control action to the battery power device.

Method 600 generates a policy that decides DVFS settings to adopt in a given device state. The policy is implemented via the policy table 200. Compared with existing DVFS governors, method 600 is device specific and performs coordinated control of both CPU and memory of device 110. Method 600 also manages energy as opposed to power. Energy is the amount of power consumed over time. The reward function reflects a design goal of saving energy under the condition of meeting performance targets. The performance target is a number of fps that provide a quality experience. 24 fps is an example target. Note that method 600 may be performed during initial video playback in a manner that is mostly transparent to a user of the device, as the video is continuously played during method 600, albeit with likely different quality levels for short periods. Thus, the runtime environment is taken into account, as opposed to using profiles generated prior to playing videos that do not take the runtime environment into account.

FIG. 7 is an example of a snapshot of a learning table 700 of multiple device states and corresponding reward calculations for multiple different actions in each device state during learning conducted by the learning agent 145. Each row corresponds to one state and each column corresponds to one action. Once learning is completed, learning table 700 will have an entry for each of the different possible device states. Learning table 700 is similar to the above-mentioned policy table 200 and is used to generate the policy table 200 once learning is completed. During learning, learning table 700 is temporary and dynamic, as it is updated with each different state entered during learning.

In learning table 700, the reward values for the state-action pairs are indicated in brackets: “{ }”. For example, the third row in learning table 700 is for state 3. The fifth action in that row has the largest associated reward of 1.4000. Learning table 700 is updated dynamically during the learning process. The numbers at the far right of each row represent the best action for the state the row represents, starting with action 0. The fifth action in row 3 is thus represented by the number 4. A-1 indicates that the state was not visited yet during learning. The fifth action, comprising a particular CPU f and Mem BW is selected for inclusion in the policy table 200 for state 4. Each state may be looked at similarly using a max function or similar function, with the results used to fully populate the policy table 200.

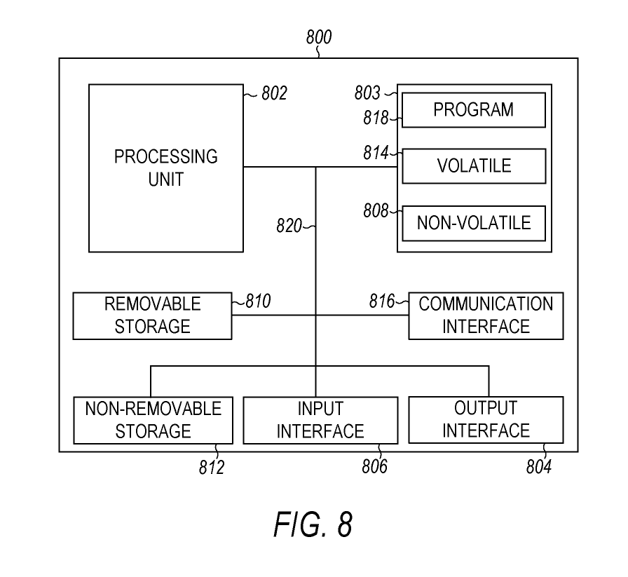

FIG. 8 is a block diagram illustrating circuitry for learning battery powered device settings for balancing energy utilization with quality video playback to minimize energy consumption during video playback and performing other methods according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, or other computing device including the same or similar elements as illustrated and described with regard to FIG. 8. Devices, such as smartphones, tablets, and smartwatches, are generally collectively referred to as mobile devices or user equipment. Further, although the various data storage elements are illustrated as part of the computer 800, the storage may also or alternatively include cloud-based storage accessible via a network, such as the Internet or server based storage.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices.

The computer may operate in a networked environment using a communication connection to connect to one or more remote computers, such as database servers. The remote computer may include a personal computer (PC), server, router, network PC, a peer device or other common DFD network switch, or the like. The communication connection may include a Local Area Network (LAN), a Wide Area Network (WAN), cellular, WiFi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software that, when executed by the processing unit 802, performs network switch operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 818 may be used to cause processing unit 802 to perform one or more methods or algorithms described herein.

Although a few embodiments have been described in detail above, other modifications are possible. For example, the logic flows depicted in the figures do not require the particular order shown, or sequential order, to achieve desirable results. Further, while the methods described relate to video playback, other CPU or memory intensive apps may utilize similar reward based learning to select energy management settings during execution of the apps. Other steps may be provided, or steps may be eliminated, from the described flows, and other components may be added to, or removed from, the described systems. Other embodiments may be within the scope of the following claims.

What is claimed is:

1. A computer implemented method of controlling energy consumption of a battery powered device, the method comprising:
determining, by the device, a state of the device responsive to the device playing a video wherein the state of the device is based on a CPU utilization rate of a CPU of the device;
selecting, by the device, a policy of a plurality of different policies based on the determined state, wherein each policy comprises a respective CPU frequency setting and a respective memory bandwidth setting; and
applying, by the device, the CPU frequency setting of the selected policy to the CPU and the memory bandwidth setting of the selected policy to a speed setting of a memory bus of the device.

2. The method of claim 1, further comprising:
for each of a plurality of different combinations of CPU frequency settings and memory bandwidth settings:
determining, by the device, a respective first state of the device responsive to the device playing a first video;
applying, by the device, the CPU frequency setting of the combination to the CPU and the memory bandwidth setting of the combination to the speed of the memory bus and, thereafter, computing a reward value for combination based on a fps of the first video and power utilization of the device during playing of the first video; and
associating, by the device, the first state and the reward value with the combination.

3. The method of claim 2, further comprising:
selecting, by the device, a combination having a greatest reward value among combinations associated with each different first state to produce the plurality of policies.

4. The method of claim 2 wherein computing the reward value for the combination comprises:
calculating
$$\frac{1}{max ( 0 , F - fps ) + \tilde{λ} * power} ,$$
where F is a target frames per second, fps is a value of the frames per second of the first video while it is playing, λ is a power penalty constant, and power is a rate of power utilization of the CPU while the first video is playing.

5. The method of claim 4 wherein fps=24 and λ<1.

6. The method of claim 2 wherein the combinations are evaluated in a random order.

7. A battery powered device comprising:
a memory storage device comprising instructions; and
a central processing unit (CPU) in communication with the memory storage device, wherein the CPU is configured to execute the instructions to perform operations comprising:
determining, by the device, a state of the device responsive to the device playing a video wherein the state of the device is based on a CPU utilization rate of a CPU of the device;
selecting, by the device, a policy of a plurality of different policies based on the determined state, wherein each policy comprises a respective CPU frequency setting and a respective memory bandwidth setting; and
applying the CPU frequency setting of the selected policy to the CPU and the memory bandwidth setting of the selected policy to a speed setting of a memory bus of the device.

8. The device of claim 1, further comprising:
for each of a plurality of different combinations of CPU frequency settings and memory bandwidth settings:
determining, by the device, a respective first state of the device responsive to the device playing a first video;
applying, by the device, the CPU frequency setting of the combination to the CPU and the memory bandwidth setting of the combination to the speed of the memory bus and, thereafter, computing a reward value for combination based on a fps of the first video and power utilization of the device during playing of the first video; and
associating, by the device, the first state and the reward value and with the combination.

9. The device of claim 8, further comprising:
selecting, by the device, a combination having a greatest reward value among combinations associated with each different first state to produce the plurality of policies.

10. The device of claim 8 wherein computing the reward value for the combination comprises:
calculating
$$\frac{1}{max ( 0 , F - fps ) + \tilde{λ} * power} ,$$
where F is a target frames per second, fps is a value of the frames per second of the first video while it is playing, λ is a power penalty constant, and power is a rate of power utilization of the CPU while the first video is playing.

11. The device of claim 7 wherein fps=24 and λ<1.

12. The device of claim 8 wherein the combinations are evaluated in a random order.

13. A non-transitory computer-readable media storing computer instruction for controlling energy consumption of a device, that when executed by a central processing unit (CPU), cause the CPU to perform the steps of:
determining, by the device, a state of the device responsive to the device playing a video wherein the state of the device is based on a CPU utilization rate of a CPU of the device;
selecting, by the device, a policy of a plurality of different policies based on the determined state, wherein each policy comprises a respective CPU frequency setting and a respective memory bandwidth setting; and
applying the CPU frequency setting of the selected policy to the CPU and the memory bandwidth setting of the selected policy to a speed setting of a memory bus of the device.

14. The computer-readable media of claim 13, further comprising:
for each of a plurality of different combinations of CPU frequency settings and memory bandwidth settings:
determining, by the device, a respective first state of the device responsive to the device playing a first video;
applying, by the device, the CPU frequency setting of the combination to the CPU and the memory bandwidth setting of the combination to the speed of the memory bus and, thereafter, computing a reward value for combination based on a fps of the first video while it is playing and power utilization of the device during playing of the first video; and
associating, by the device, the first state and the reward value and with the combination.

15. The computer-readable media of claim 14, further comprising:
selecting, by the device, a combination having a greatest reward value among combinations associated with each different first state to produce the plurality of policies.

16. The computer-readable media of claim 14 wherein computing the reward value for the combination comprises:
calculating
$$\frac{1}{max ( 0 , F - fps ) + \tilde{λ} * power} ,$$
where F is a target frames per second, fps is a value of the frames per second of the first video while it is playing, λ is a power penalty constant, and power is a rate of power utilization of the CPU while the first video is playing.

17. The computer-readable media of claim 16 wherein fps=24 and λ<1.

18. The computer-readable media of claim 14 wherein the combinations are evaluated in a random order.
